(19) United States
(12) Patent Application Publication
(10) Pub. No.: US 2025/0263206 A1
(43) Pub. Date: Aug. 21, 2025

(54) VEHICLE WINTERIZATION CAP

(71) Applicants: Collin Lenwwod Reese, JR., Grand Junction, CO (US); Drayton T. Reese, Mechanicsville, MD (US)

(72) Inventors: Collin Lenwwod Reese, JR., Grand Junction, CO (US); Drayton T. Reese, Mechanicsville, MD (US)

(21) Appl. No.: 18/891,111

(22) Filed: Sep. 20, 2024

Related U.S. Application Data
(60) Provisional application No. 63/555,615, filed on Feb. 20, 2024.

(51) Int. Cl. B65D 41/04

(52) U.S. Cl. CPC B65D 41/0442

(57) ABSTRACT

A winterization cap configured to reduce the usage of winterization fluids is provided. The winterization cap can be monolithically formed to include a plurality of components such as a body, a plurality of grips, an attachment means, and at least one seal. The body can be tubular in shape having the attachment means monolithically formed on either an inner surface or an outer surface. At least one seal can be provided on an interior portion of the body and is configured to prevent leakage of winterization fluids. The plurality of grips can be monolithically formed to portions of the winterization cap and are configured to allow ease of installation or removal of the cap. To use the winterization cap, a user can remove a filter housing from a plumbing system and affix the cap utilizing the attachment means to the plumbing system.

### CROSS-REFERENCE TO RELATED APPLICATION

This application claims the benefit of priority of U.S. provisional application No. 63/555,615, filed Feb. 20, 2024, the contents of which are herein incorporated by reference.

### BACKGROUND OF THE INVENTION

### Field of Invention

The present invention relates to winterization of plumbing systems, and more particularly, to a filter cap for reducing the amount of antifreeze necessary for winterization of plumbing systems of recreational vehicles.

### Background of Related Art

Winterization of recreational vehicles (RVs) is a resource and labor-intensive process that requires a user, or users, to replace the water in the RVs plumbing system with antifreeze. Prior art solutions have focused on reducing the amount of labor required by providing mechanisms for pumping antifreeze into the plumbing while evacuating water from the plumbing. However, prior art solutions still require large amounts of antifreeze to fully protect the plumbing systems of RVs.

As can be seen, there is a need for a filter cap for RV plumbing systems to reduce the amount of antifreeze required to fully protect an RVs plumbing system.

### SUMMARY OF THE INVENTION

In one aspect of the present invention, a first winterization cap is provided and is configured to reduce the amount of winterization fluids utilized in a plumbing system. The first winterization cap can be monolithically formed and can include a plurality of components such as a body, a shelf, or shoulder portion, a cap, a plurality of grips, at least one seal, and an attachment means. The body of the winterization cap can be substantially tubular with an outer surface having a first diameter and an inner surface having a second diameter. A shelf, or shoulder portion, can be continuously formed to both the body portion and the cap portion and can be shaped as a conical frustum. The plurality of grips can be continuously formed to the body, shelf and cap, and can be configured to provide ease of gripping to a user when installing or removing the winterization cap. The seal can be disposed on the interior of the winterization cap, for example, in a recessed portion on an interior surface of the shelf, or shoulder, and can be configured to aid in preventing fluid leakage, or loss. The attachment means can be threading, such as female threading and can be continuously formed on the inner surface of the body.

In another aspect of the present invention, a second winterization cap is provided. The second winterization cap differs from the first winterization cap in the positioning of the attachment means, and the at least one seal. In the second winterization cap, the attachment means can be threading, such as male threading and can be continuously formed on the outer surface of the body. Additionally, the at least one seal can be installed in a recessed portion of the second winterization cap, however, in this embodiment, the recessed portion can be on a surface that connects the inner surface of the body to the outer surface of the body.

In usage, both the first winterization cap and the second winterization cap can be installed on a plumbing system after a filter housing is removed from the plumbing system. A user can install the at least one seal, or the at least one seal can be previously installed. A user can grip, or grasp, the first or second winterization cap by the plurality of grips and can install or remove the first or second winterization cap by turning in a first, or second direction, respectively. Advantageously, installation of the first or second winterization cap prevents usage of a volume of winterization fluid equal to the volume of the filter housing removed.

These and other features, aspects and advantages of the present invention will become better understood with reference to the following drawings, description, and claims.

### BRIEF DESCRIPTION OF THE DRAWINGS

FIG. 1 is a perspective view of an embodiment of a winterization cap shown in use, according to aspects of the present invention;

FIG. 2 is a top perspective view of an embodiment of a winterization cap, according to aspects of the present invention;

FIG. 3 is a bottom perspective view of an embodiment of a winterization cap, according to aspects of the present invention;

FIG. 4 is an exploded view of an embodiment of a winterization cap shown in use, according to aspects of the present invention;

FIG. 5 is a cross-sectional view of an embodiment of a winterization cap taken along line 5-5 of FIG. 1, according to aspects of the present invention;

FIG. 6 is a perspective view of an alternative embodiment of a winterization cap show in use, according to aspects of the present invention;

FIG. 7 is an exploded view of an alternative embodiment of a winterization cap shown in user, according to aspects of the present invention; and

FIG. 8 is a cross-sectional view of an alternative embodiment of a winterization cap taken along line 8-8 of FIG. 7, according to aspects of the present invention.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

As stated above, current attempts to reduce resources associated with winterization of RVs have been focused on reducing the amount of labor required to exchange antifreeze for water in the plumbing systems of RVs. Currently, no attempts have been made to reduce the amount of antifreeze used in plumbing systems. The amount of antifreeze needed is a function of the total length of plumbing in an RV and the number of filters used, because plumbing cannot be removed without significant time, labor and cost, removing filters is the most effective way to save on antifreeze usage. Currently, most RV plumbing systems have more than 1, typically 2-4, filter(s) that require(s) at least half of a gallon of antifreeze, thus removing filters could save gallons of antifreeze. However, removal of filters leaves an uncapped pipe for antifreeze to leak from thus defeating the purpose of winterization.

Broadly, one embodiment of the present invention is a filter cap system configured to replace a filter housing in a plumbing system. The present invention can include a cap, or lid, having protrusions on an outer surface thereof, which are configured to improve grip during a twisting, or turning, motion. An internal portion of the present invention can include female threading configured to secure the present invention to a fixture, and at least one seal disposed in a recessed portion of the internal portion and configured to prevent leakage. Advantageously, the present invention can be installed in place of a filter housing thereby reducing the amount of antifreeze required for winterization by a volume of the filter.

Broadly, another embodiment of the present invention is a filter cap configured to replace a filter housing, and/or cap the filter housing, in a plumbing system. This embodiment can include a cap, or lid, having protrusions on an outer surface thereof, which are configured to improve grip during a twisting, or turning, motion. Male threading can be provided on an external portion of the alternate embodiment of the present invention which can be configured to secure the invention to a fixture. Additionally, at least one seal can be disposed about a rim of the alternate embodiment which can be configured to prevent leakage. Advantageously, the present invention can be installed in place of a filter housing thereby reducing the amount of antifreeze required for winterization by a volume of the filter.

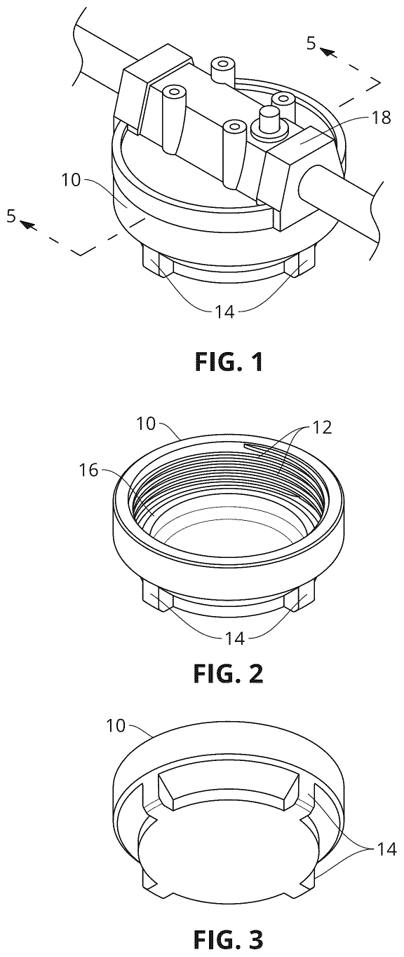

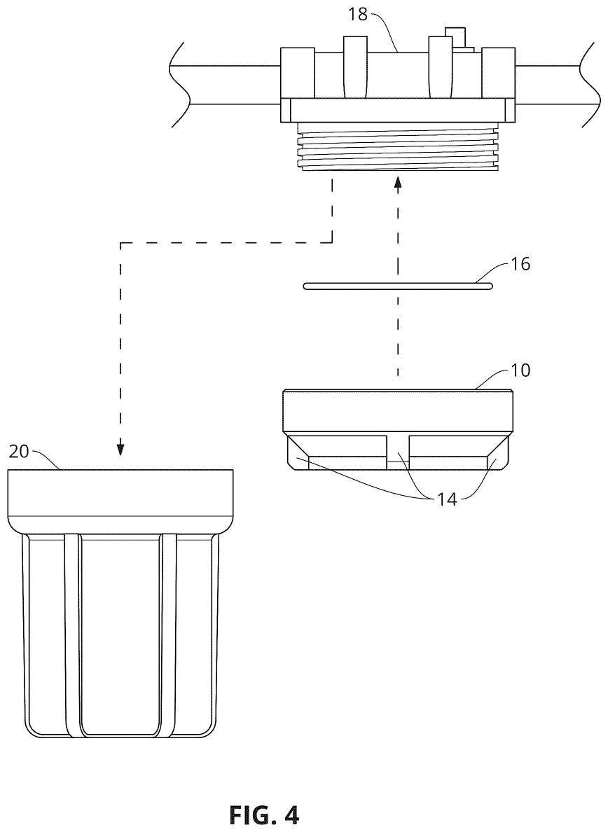

Referring to FIGS. 1-5, a first embodiment of a winterization cap is illustrated. FIG. 1 illustrates the winterization cap installed on a ported filter top 18 of a plumbing system. The Winterization cap can be installed on ported filter top 18 by grasping, or gripping a plurality of grips 14, protruding from a body 10 of the winterization cap, and twisting body 10 to engage fastening means such as threading. The Winterization cap can be formed of any material known in the art, of sufficient structural integrity to withstand the pressure of plumbing systems, such as plastics, metals, carbon fiber, etc. Additionally, the winterization cap can be sized or dimensioned to fit any known fixture having the corresponding fastening means.

FIG. 2 illustrates aspects of a first embodiment of a winterization cap, according to aspects of the present invention. Winterization cap can have a body 10 which can be monolithically formed to include a plurality of components such as a base, a shelf, or shoulder portion, a plurality of grips 14, and a cap portion. In embodiments, base of body 10 can be shaped in a tubular configuration, or a hollow cylinder, having an outer surface with a first diameter, or first radius, and an inner surface with a second diameter, or second radius, wherein the diameters and/or radius are defined conventionally. In embodiments, a wall thickness of the base of body 10 can be defined as the distance between the outer surface and the inner surface.

Shelf, or shoulder portion, of body 10 can be monolithically formed and can be disposed between the base of body 10 and the cap portion of body 10 (as seen in FIGS. 2-3). Shelf, or shoulder portion, can be substantially shaped as a conical frustum having a bottom base having a first radius and a top base having a second radius smaller than the first radius. In embodiments, shelf, or shoulder portion, of body 10 can form an incline from the outer surface of base of body 10 to the cap portion of body 10 (as seen in FIGS. 2-3). In embodiments, shelf, or shoulder portion, can form a base of attachment where the plurality of grips 14 are monolithically formed (as seen in FIGS. 2-3). In embodiments, shelf, or shoulder portion is configured to form recessed portions of body 10 such that a user's hand can more easily and effectively grip body 10. Additionally, inner surfaces of base of body 10 and shelf of body 10 are continuously formed and can form a volume in the negative space defined by the inner surfaces.

Cap portion of body 10 can be monolithically formed and can be disposed at the top base of shelf, or shoulder portion, distal from base of body 10 (as seen in FIGS. 2-3). In embodiments, cap portion of body 10 can be substantially cylindrical in shape, can be monolithically formed to plurality of grips 14 (as seen in FIGS. 2-3). In embodiments, cap portion of body 10, in concert with other components, prevents leakage or loss of winterization fluids when body 10 is affixed to a plumbing system.

Plurality of grips 14 can be continuously formed to one or more of an outer surface of base, shelf, or cap of body 10, and can be configured to improve a user's grip on the winterization cap during installation and/or removal. In embodiments, plurality of grips 14 can be uniformly dispersed about the aforementioned outer surface. In embodiments, plurality of grips 14 can be shaped as a plurality of protrusions, such as prisms, and/or pyramids, but are generally formed as irregular substantially polyhedral shapes. Advantageously, the plurality of grips provide additional structures to apply force during a twisting, or turning, movement.

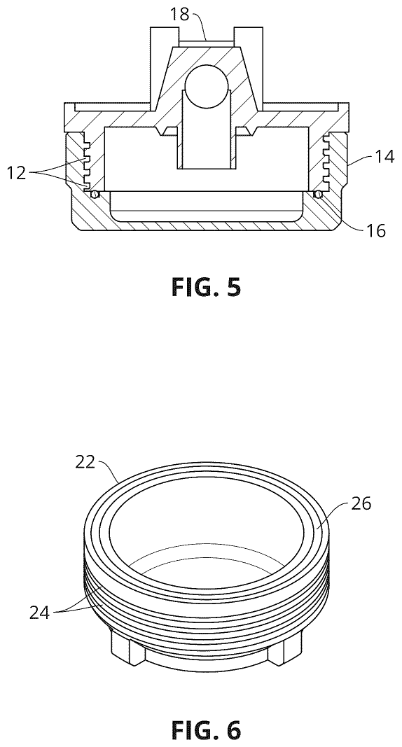

In this embodiment an attachment means 12 and seal 16 can assist in preventing leakage or loss of winterization fluids when body 10 is affixed to a plumbing system (as seen in FIGS. 2, 4 and 5). In this embodiment, seal 16 can be an O-ring, or other known seal or gasket, which can be disposed along an interior portion of body 10 proximate to an inner portion of shelf, or shoulder portion (as seen in FIGS. 2 and 5). In embodiments, an interior portion of shelf, or shoulder portion, such as an interior portion of the bottom base, can include a recessed portion, or aperture, size to fit seal 16 (as seen in FIG. 5). In embodiments, the recessed portion can be sized such that seal 16 can be installed and fit securely. Advantageously, seal 16 can aid in the prevention of fluid leakage or loss when seated against top ported filter 18.

In this embodiment attachment means 12 can be continuously, or monolithically, formed to the inner surface of base of body 10. In this embodiment, attachment means 12 can be female threading such as, continuous threading, lug/twist cap, friction fit and/or triple threading (as seen in FIGS. 2 and 5). It is envisioned that any known means of attachment can be used without departing from the scope of the invention. It is understood, that attachment means 12 can be dimensioned or sized to accommodate plumbing systems.

Referring now to usage of the first embodiment, a user can remove a filter housing 20 from the top ported filter 18, exposing the threading of the top ported filter 18. Seal 16 can be installed, concurrently, or previously, into body 10. Once seal 16 is installed, a user can grip, or grasp, body 10 by plurality of grips 14 and twistably affix body 10 to top ported filter 18. Once body 10 is affixed, a user can repeat the process, as necessary, for any additional filters of the plumbing system. Once all filters are capped, the user can then introduce winterization fluids, such as antifreeze, into the plumbing system. Advantageously, body 10 prevent excess usage of winterization fluids by preventing the volume of filter housing 20 from being filled with winterization fluids.

Referring to FIGS. 6-8, a second embodiment of a winterization cap is illustrated. FIG. 6 illustrates aspects of a second embodiment of a winterization cap, according to the present invention. Winterization cap can have a body 22 which can be monolithically formed to include a plurality of components such as a base, a shelf, or shoulder portion, a plurality of grips (Unlabeled), and a cap portion. In embodiments, base of body 22 can be shaped in a tubular configuration, or a hollow cylinder, having an outer surface with a first diameter, or first radius, and an inner surface with a second diameter, or second radius, wherein the diameters and/or radius are defined conventionally. In embodiments, a wall thickness of the base of body 22 can be defined as the distance between the outer surface and the inner surface.

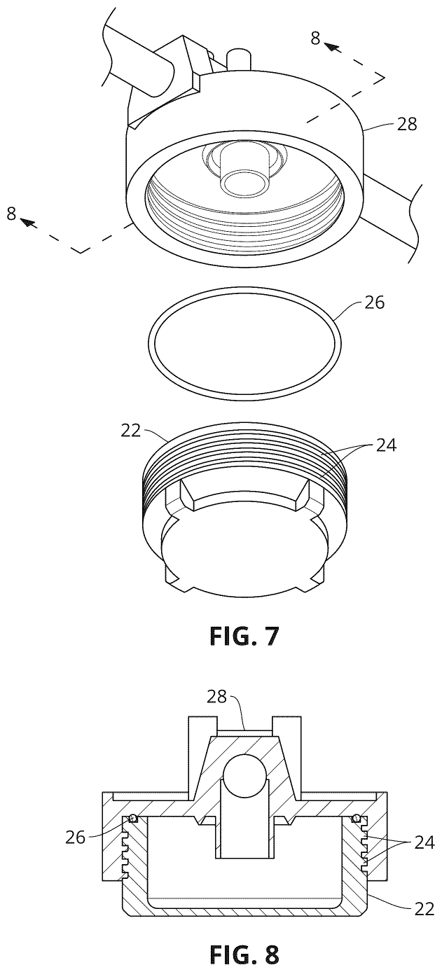

Shelf, or shoulder portion, of body 22 can be monolithically formed and can be disposed between the base of body 22 and the cap portion of body 22 (as seen in FIGS. 6-8). Shelf, or shoulder portion, can be substantially shaped as a conical frustum, forming an incline from the base of body 22 to the cap portion of body 22 (as seen in FIGS. 6-7). In embodiments, shelf, or shoulder portion, can form a base of attachment where the plurality of grips (Unlabeled) are monolithically formed (as seen in FIGS. 6-7). In embodiments, shelf, or shoulder portion is configured to form recessed portions of body 22 such that a user's hand can more easily and effectively grip body 22.

Cap portion of body 22 can be monolithically formed and can be disposed at an edge of shelf, or shoulder portion, distal from base of body 22 (as seen in FIGS. 6-7). In embodiments, cap portion of body 22 can be substantially cylindrical in shape, can be monolithically formed to plurality of grips (Unlabeled) (as seen in FIGS. 6-7). In embodiments, cap portion of body 22, in concert with other components, prevents leakage or loss of winterization fluids when body 22 is affixed to a plumbing system.

In this embodiment an attachment means 24 and seal 26 can assist in preventing leakage or loss of winterization fluids when body 22 is affixed to a plumbing system (as seen in FIGS. 6-8). In this embodiment, seal 26 can be an O-ring, or other known seal or gasket, which can be disposed along an interior portion of body 22. In embodiments, an interior portion of base can include a recessed portion, or aperture, size to fit seal 26 (as seen in FIGS. 6 and 8). In embodiment, the recessed portion can be disposed on a surface connecting the inner surface to the outer surface. In embodiments, the recessed portion can be sized such that seal 26 can be installed and fit securely. Advantageously, seal 26 can aid in the prevention of fluid leakage or loss when seated against a plumbing system 28.

In this embodiment attachment means 24 can be continuously, or monolithically, formed to the outer surface of base of body 22. In this embodiment, attachment means 24 can be male threading such as, continuous threading, lug/twist cap, friction fit and/or triple threading (as seen in FIGS. 6-8). It is envisioned that any known means of attachment can be used without departing from the scope of the invention. It is understood, that attachment means 24 can be dimensioned or sized to accommodate plumbing systems.

Referring now to usage of the second embodiment, a user can remove a filter from the top ported filter 28, exposing the threading of the top ported filter 28. Seal 26 can be installed, concurrently, or previously, into body 22. Once seal 26 is installed, a user can grip or grasp body 22 by plurality of grips (unlabeled) and twistably affix body 22 to top ported filter 28. Once body 22 is affixed, a user can repeat the process, as necessary, for any additional filters of the plumbing system. Once all filters are capped, the user can then introduce winterization fluids into the plumbing system. Advantageously, body 22 prevent excess usage of winterization fluids by preventing the volume of the filter from being filled with winterization fluids. It is understood, in this usage case that the first embodiment of the filter cap could then be used as a cap for any filter housing installed on ported filter 28, as the attachment means 12 of the first embodiment would match the attachments of any filter housing installed. Advantageously, utilization of the first embodiment in this way would prevent degradation of any filter stored in the filter housing due to exposure to environmental elements.

Referring now to an additional usage of the second embodiment, a user could utilizing the second embodiment of the winterization cap to protect a filter in filter housing 20 from debris and/or degradation during storage. A user could affix body 22 into housing 20 thereby creating a seal and preventing any degradation of a filter due to exposure to environmental elements. Advantageously, body 22 can provide longer lifespan for filters in housing 22 by preventing introduction of contaminants from the environment.

It should be understood, that common elements between the first embodiment and second embodiment may not be separately described. It should be understood, of course, that the foregoing relates to exemplary embodiments of the invention and that modifications may be made without departing from the spirit and scope of the invention as set forth in the following claims.

What is claimed is:

1. A winterization cap, comprising:
a tubular body with an outer surface having a first diameter, an inner surface with a second diameter, and a recessed portion;
a plurality of grips, each of the plurality of grips continuously formed to the tubular body;
a seal disposed on the recessed portion; and
an attachment means continuously formed on the tubular body.

2. The winterization cap of claim 1, wherein the attachment means is continuously formed on the inner surface of the tubular body.

3. The winterization cap of claim 1, wherein the attachment means is continuously formed on the outer surface of the tubular body.

4. The winterization cap of claim 1, wherein the attachment means is threading.

5. The winterization cap of claim 4, wherein the threading is female threading.

6. The winterization cap of claim 4, wherein the threading is male threading.

7. The winterization cap of claim 1, further comprising:
substantially cylindrical cap; and
a conical frustum shaped shelf continuously formed at a first interface to the tubular body and at a second interface to the substantially cylindrical cap.

8. The winterization cap of claim 7, wherein the recessed portion is disposed on a third surface.

9. The winterization cap of claim 7, wherein the third surface disposed between the inner surface and the outer surface.

10. The winterization cap of claim 7, wherein the third surface is an interior surface of the conical frustum shaped shelf.
